(19) United States
(12) Patent Application Publication
(10) Pub. No.: US 2026/0328358 A1
(43) Pub. Date: Oct. 22, 2026

(54) LIGHT CONTROL DEVICE AND ILLUMINATION DEVICE

(71) Applicant: Japan Display Inc., Tokyo (JP)

(72) Inventors: Daisuke HAMANO, Tokyo (JP); Takeo KOITO, Tokyo (JP)

(21) Appl. No.: 19/703,595

(22) Filed: Jun. 10, 2026

Related U.S. Application Data
(63) Continuation of application No. PCT/JP2024/035076, filed on Oct. 1, 2024.

(30) Foreign Application Priority Data
Dec. 15, 2023 (JP) 2023-212258

(51) Int. Cl. F21S 41/64

(52) U.S. Cl. CPC F21S 41/645

(57) ABSTRACT

A light control device includes: a liquid crystal element transmits light incident along a first direction to cause the incident light to exit as transmitted light; and a lens on which the transmitted light is incident. A first region of the liquid crystal element causes the incident light to exit in the first direction when no potential is applied, and exit in a second direction when potential is applied. A second region of the liquid crystal element causes the incident light to exit in the first direction. The lens has: a first surface through which the transmitted light is diffused and exits; and a second surface that totally reflects the transmitted light incident along the first direction toward the first surface in a third direction, and refracts the transmitted light incident along the second direction to cause the light to exit in a fourth direction away from the first surface.

### CROSS-REFERENCE TO RELATED APPLICATION

This application claims the benefit of priority from Japanese Patent Application No. 2023-212258 filed on Dec. 15, 2023 and International Patent Application No. PCT/JP2024/035076 filed on Oct. 1, 2024, the entire contents of which are incorporated herein by reference.

### BACKGROUND

### 1. Technical Field

What is disclosed herein relates to a light control device and an illumination device.

### 2. Description of the Related Art

Japanese Patent Application Laid-open Publication No. 2019-50134 (JP-A-2019-50134) discloses, as an example of a light control device, a vehicle headlamp capable of controlling an illumination region (illumination area). The vehicle headlamp of JP-A-2019-50134 includes a light source, a polarization beam splitter, a reflector, and a liquid crystal element. Light from the light source is split into two polarized light beams by the polarization beam splitter. One of the two polarized light beams is reflected by the polarization beam splitter and travels toward the liquid crystal element. The other of the two polarized light beams passes through the polarization beam splitter, is reflected by the reflector, and travels toward the liquid crystal element. That is, the two polarized light beams are collected onto the liquid crystal element. As a result, the efficiency of use of light from the light source can be improved.

In the light control device of JP-A-2019-50134, the direction of polarized light needs to be accurately adjusted so that the polarized light is incident on the liquid crystal element. The direction of polarized light varies depending on dimensional variations and disposition of the members. Thus, in the light control device of JP-A-2019-50134, relatively high accuracy is required for the dimensions and positions of disposition of the members. Therefore, it is difficult to easily change the illumination area.

For the foregoing reasons, there is a need for a light control device capable of easily changing an illumination area.

### SUMMARY

According to an aspect, a light control device includes: a liquid crystal element including a first substrate, a second substrate, and a liquid crystal layer between the first substrate and the second substrate, the liquid crystal element being configured to transmit incident light that is incident along a first direction to cause the incident light to exit therefrom as transmitted light; and a lens on which the transmitted light from the liquid crystal element is incident and that has a first surface through which the transmitted light is diffused and exits. The liquid crystal element includes: a first region in which a plurality of element sets are disposed on the first substrate, each element set including an electrical resistance film and a first electrode and a second electrode electrically coupled to the electrical resistance film while facing each other, and in which a third electrode overlapping the electrical resistance film in plan view is disposed on the second substrate; and a second region in which the electrical resistance film is not disposed. The first region of the liquid crystal element is configured to cause the incident light to exit in the first direction when no potential is applied to the element sets and the third electrode, and cause the incident light to exit in a second direction different from the first direction when potential is applied to the element sets and the third electrode. The second region of the liquid crystal element is configured to cause the incident light to exit in the first direction. The lens further has a second surface that totally reflects the transmitted light incident along the first direction toward the first surface in a third direction, and that refracts the transmitted light incident along the second direction to cause the transmitted light to exit therethrough in a fourth direction away from the first surface.

According to an aspect, an illumination device includes the light control device and a light source configured to emit light to be incident on the light control device.

### BRIEF DESCRIPTION OF THE DRAWINGS

FIG. 1 is a diagram illustrating the configuration of an illumination device according to an embodiment of the present disclosure;

FIG. 2 is a plan view of a liquid crystal element;

FIG. 3 is a sectional view of the liquid crystal element taken along line III-III illustrated in FIG. 2;

FIG. 4 is a diagram illustrating the potential of an electrical resistance film when the liquid crystal element refracts incident light, and the phase difference of incident light passing through a liquid crystal layer;

FIG. 5 is a diagram illustrating a first illumination area;

FIG. 6 is a diagram illustrating a second illumination area; and

FIG. 7 is a diagram illustrating a third illumination area illuminated by the illumination device according to a modification of the embodiment of the present disclosure.

### DETAILED DESCRIPTION

An embodiment of the present disclosure is described below with reference to the drawings. Contents described below in the embodiments do not limit the present disclosure. Components described below include those that could be easily thought of by the skilled person in the art and those identical in effect. Components described below may be combined as appropriate.

What is disclosed herein is only an example, and any modifications that can be easily conceived by those skilled in the art while maintaining the main purpose of the present disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

An X direction and a Y direction illustrated in the drawings correspond to directions parallel to the plate surface of a substrate of a liquid crystal element to be described later. A Z direction corresponds to the thickness direction of the liquid crystal element. The X, Y, and Z directions are orthogonal to each other. In the present specification, a “plan view” is a view of the liquid crystal element viewed in the Z direction. The X, Y, and Z directions are exemplary, and the present disclosure is not limited to these directions.

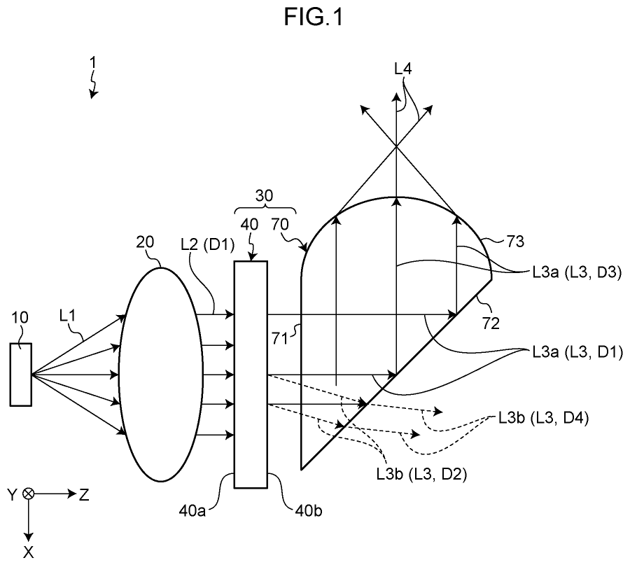

FIG. 1 is a diagram illustrating the configuration of an illumination device 1 according to an embodiment of the present disclosure. The illumination device 1 is, for example, a vehicle headlight or a spotlight. The illumination device 1 includes a light source 10, a first lens 20, and a light control device 30. The light control device 30 includes a liquid crystal element 40 and a second lens 70 (corresponding to “lens”).

The light source 10 emits light L1 to be incident on the light control device 30. Specifically, the light L1 from the light source 10 is incident on the liquid crystal element 40 through the first lens 20. The light source 10 is, for example, a light emitting diode (LED).

The first lens 20 is an optical element that collimates the traveling direction of the light L1 from the light source 10. The first lens 20 is a collimating lens. The first lens 20 collimates incident light L2 that is incident on the liquid crystal element 40, and the collimated light exits therefrom.

The liquid crystal element 40 is a refractive plate that refracts the incident light L2. The liquid crystal element 40 has a first incident surface 40a (surface on the negative Z side) on which the incident light L2 is incident. A direction in which the incident light L2 (collimated light) travels is defined as a first direction D1. The first direction D1 is parallel to the Z direction. The liquid crystal element 40 transmits the incident light L2 that is incident along the first direction D1, and causes the incident light L2 to exit therefrom as transmitted light.

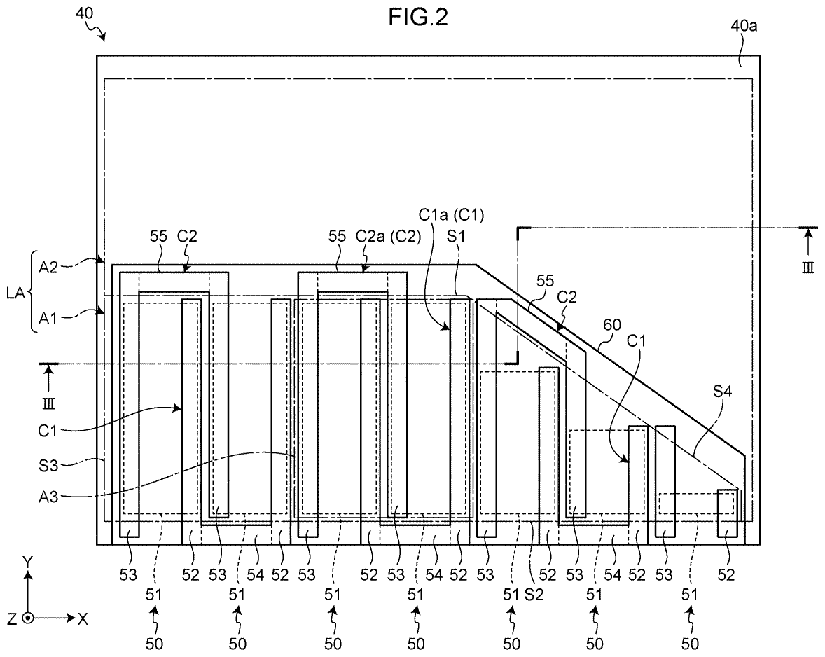

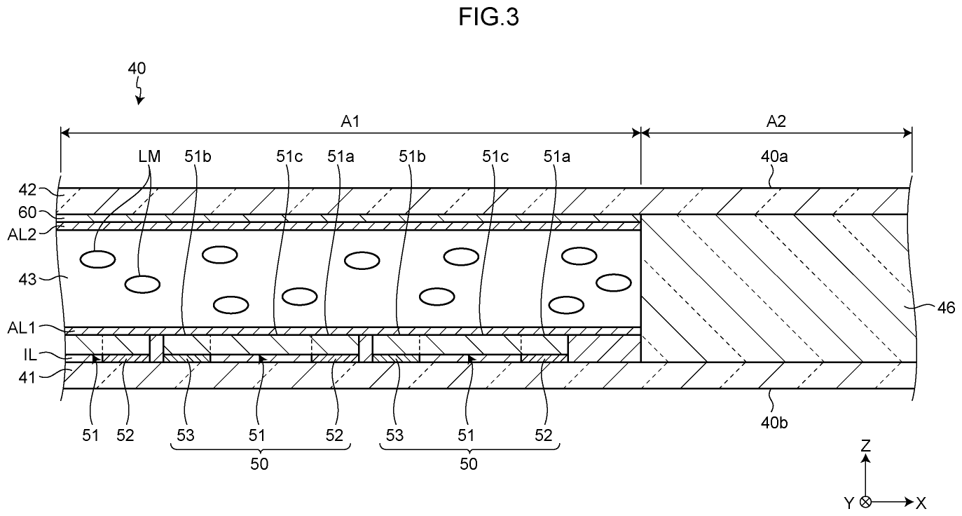

FIG. 2 is a plan view of the liquid crystal element 40. FIG. 3 is a sectional view of the liquid crystal element 40 taken along line III-III illustrated in FIG. 2. The first incident surface 40a includes an incident region LA in which the incident light L2 is incident.

As illustrated in FIG. 3, the liquid crystal element 40 includes a first substrate 41, a second substrate 42, and a liquid crystal layer 43 between the first substrate 41 and the second substrate 42. The first substrate 41 and the second substrate 42 have a light-transmitting property. The first substrate 41 and the second substrate 42 are, for example, glass substrates, resin substrates, or resin films.

As illustrated in FIG. 2, the incident region LA of the liquid crystal element 40 includes a first region A1 and a second region A2.

The first region A1 is the negative Y side of the incident region LA. The first region A1 has four sides in plan view and has a substantially trapezoidal shape. Among the four sides, a first side S1 and a second side S2 extend in the X direction and face each other in the Y direction. The first side S1 is shorter than the second side S2. A third side S3 extends in the Y direction and couples the first side S1 and second side S2 on the negative X side. A fourth side S4 extends in a direction tilted relative to the X and Y directions from an end of the first side S1 on the positive X side, and faces the second side S2 in the Y direction.

The second region A2 is a region other than the first region A1 in the incident region LA in plan view.

As illustrated in FIGS. 2 and 3, a plurality of element sets 50 and a third electrode 60 are disposed in the first region A1.

Specifically, the element sets 50 are disposed on the first substrate 41. Each element set 50 includes an electrical resistance film 51, a first electrode 52, and a second electrode 53.

The electrical resistance film 51 has a strip shape extending in the Y direction in plan view. The material of the electrical resistance film 51 is a conductive material having a light-transmitting property, such as indium gallium zinc oxide (IGZO). The electric resistance value of the electrical resistance film 51 is larger than the electric resistance values of the first electrode 52 and the second electrode 53.

The first electrode 52 and the second electrode 53 are electrically coupled to the electrical resistance film 51.

In plan view, the first electrode 52 extends in the Y direction and overlaps the electrical resistance film 51 on a first end side (positive X side) of the electrical resistance film 51 in the X direction. The first electrode 52 contacts the electrical resistance film 51.

In plan view, the second electrode 53 extends in the Y direction and overlaps the electrical resistance film 51 on a second end side (negative X side) of the electrical resistance film 51 in the X direction. The second electrode 53 contacts the electrical resistance film 51.

In plan view, the first electrode 52 and the second electrode 53 overlap the electrical resistance film 51 while facing each other in the X direction.

In the electrical resistance film 51, a portion overlapping the first electrode 52 in plan view is a first overlap portion 51a, a portion overlapping the second electrode 53 in plan view is a second overlap portion 51b, and a portion between the first overlap portion 51a and the second overlap portion 51b is a middle portion 51c. In the X direction, the length of the middle portion 51c is longer than the sum of the length of the first overlap portion 51a and the length of the second overlap portion 51b.

In the present embodiment, in the X direction, an end of the electrical resistance film 51 on the positive X side coincides with an end of the first electrode 52 on the positive X side, and an end of the electrical resistance film 51 on the negative X side coincides with an end of the second electrode 53 on the negative X side, but the ends do not necessarily need to coincide.

The element sets 50 are arranged in the X direction. As described above, each element set 50 includes the strip-shaped electrical resistance film 51 extending in the Y direction. The element sets 50 are arranged in the X direction in a state in which two electrical resistance films 51 adjacent to each other in the X direction are separated from each other.

As illustrated in FIG. 2, the electrical resistance films 51 overlap the first region A1 in plan view. The Y-directional lengths of the electrical resistance films 51 between the first side S1 and the second side S2 are equal to each other. The Y-directional lengths of the electrical resistance films 51 between the fourth side S4 and the second side S2 become shorter from the negative X side toward the positive X side.

Similarly, the Y-directional lengths of the first electrodes 52 between the first side S1 and the second side S2 are equal to each other. The Y-directional lengths of the first electrodes 52 between the fourth side S4 and the second side S2 become shorter from the negative X side toward the positive X side.

Similarly, the Y-directional lengths of the second electrodes 53 between the first side S1 and the second side S2 are equal to each other. The Y-directional lengths of the second electrodes 53 between the fourth side S4 and the second side S2 become shorter from the negative X side toward the positive X side.

The liquid crystal element 40 includes a plurality of first coupling members 54, each of which electrically couples two first electrodes 52 adjacent to each other. Hereinafter, a set composed of one of the first coupling members 54 and two of the first electrodes 52 electrically coupled to the one first coupling member 54 is referred to as a first electrode set C1. FIG. 2 illustrates three first electrode sets C1 and one first electrode 52. The number of first electrode sets C1 and the number of first electrodes 52 are not limited to the numbers illustrated in FIG. 2.

The liquid crystal element 40 also includes a plurality of second coupling members 55, each of which electrically couples two second electrodes 53 adjacent to each other. Hereinafter, a set composed of one of the second coupling members 55 and two of the second electrodes 53 electrically coupled to the one second coupling member 55 is referred to as a second electrode set C2. FIG. 2 illustrates three second electrode sets C2 and one second electrode 53. The number of second electrode sets C2 and the number of second electrodes 53 are not limited to the numbers illustrated in FIG. 2.

As illustrated in FIG. 3, an insulating layer IL and a first alignment film AL1 are disposed on the first substrate 41. The electrical resistance films 51 are electrically insulated from each other by the insulating layer IL. In the Z direction, the first alignment film AL1 is disposed on the positive Z side with respect to the element sets 50 and the insulating layer IL.

The third electrode 60 and a second alignment film AL2 are disposed on the second substrate 42. In the Z direction, the second alignment film AL2 is disposed on the negative Z side with respect to the third electrode 60.

The third electrode 60 overlaps the electrical resistance films 51 in plan view. As illustrated in FIG. 2, the third electrode 60 overlaps the first region A1 in plan view. The third electrode 60 has a trapezoidal shape.

The material of the first electrode 52, the second electrode 53, and the third electrode 60 is a conductive material having a light-transmitting property, such as indium tin oxide (ITO), indium zinc oxide (IZO), indium gallium oxide (IGO), or indium gallium zinc oxide (IGZO).

As illustrated in FIG. 3, the liquid crystal layer 43 is sandwiched between the first alignment film AL1 and the second alignment film AL2. The liquid crystal layer 43 is disposed in the first region A1. In plan view, the liquid crystal layer 43, the insulating layer IL, the first alignment film AL1, and the second alignment film AL2 overlap the first region A1 and have a substantially trapezoidal shape similar to that of the first region A1. A sealing member is disposed around the liquid crystal layer 43 in plan view.

The first alignment film AL1 and the second alignment film AL2 define the alignment (initial alignment) of liquid crystal molecules LM contained in the liquid crystal layer 43 when no voltage is applied to the liquid crystal element 40. In the initial alignment of the liquid crystal molecules LM, the long axis of each liquid crystal molecule LM is orthogonal to the Z direction. The alignment direction of the first alignment film AL1 and the alignment direction of the second alignment film AL2 are orthogonal to each other in plan view.

The liquid crystal element 40 is a twisted nematic (TN) liquid crystal element. The liquid crystal element 40 is not limited to a twisted nematic liquid crystal element.

In the second region A2, the liquid crystal layer 43 is not disposed between the first substrate 41 and the second substrate 42. Specifically, in plan view, the liquid crystal layer 43 overlaps the first region A1 and is isolated from the second region A2. The insulating layer IL, the first alignment film AL1, the second alignment film AL2, and the electrical resistance films 51 are not disposed between the first substrate 41 and the second substrate 42 in the second region A2. A resin member 46 is disposed between the first substrate 41 and the second substrate 42 in the second region A2.

The refractive index of the resin member 46 is substantially the same as the refractive indices of the first substrate 41 and the second substrate 42. Accordingly, deterioration of optical characteristics can be reduced in the second region A2. The resin member 46 does not necessarily need to be disposed between the first substrate 41 and the second substrate 42 in the second region A2. In this case, an air layer is provided between the first substrate 41 and the second substrate 42 in the second region A2. Alternatively, the liquid crystal layer 43 may be disposed between the first substrate 41 and the second substrate 42 in the second region A2.

The following describes operation in which the liquid crystal element 40 refracts the incident light L2. As illustrated in FIG. 1, in the liquid crystal element 40, the incident light L2 is incident on the first incident surface 40a in the first direction D1.

In the second region A2, the liquid crystal layer 43 is not disposed, and the liquid crystal element 40 does not refract the incident light L2. Specifically, in the second region A2 of the liquid crystal element 40, the incident light L2 passes therethrough without being refracted and exits through a first light-exit surface 40b (surface on the positive Z side). Accordingly, transmitted light L3 that exits from the liquid crystal element 40 in the second region A2 travels in the first direction D1. Hereinafter, the transmitted light L3 that exits from the liquid crystal element 40 in the first direction D1 is referred to as first transmitted light L3a.

When no potential is applied to the element sets 50 and the third electrode 60 in the first region A1, the liquid crystal molecules LM in the liquid crystal layer 43 remain in the initial alignment, and the liquid crystal element 40 does not refract the incident light L2. In this case, in the first region A1 of the liquid crystal element 40, no phase difference occurs in the incident light L2, and the incident light L2 passes therethrough without being refracted and exits through the first light-exit surface 40b as the first transmitted light L3a.

When potential is applied to the element sets 50 and the third electrode 60 in the first region A1, the incident light L2 is refracted in the first region A1 of the liquid crystal element 40 as described later, and exits through the first light-exit surface 40b in a second direction D2. The second direction D2 is a direction different from the first direction D1. Specifically, the second direction D2 is a direction tilted toward the positive X side from the first direction D1 (Z direction). Hereinafter, the transmitted light L3 that exits from the liquid crystal element 40 in the second direction D2 is referred to as second transmitted light L3b. The first transmitted light L3a and the second transmitted light L3b are simply referred to as “transmitted light L3” when they are described without distinction.

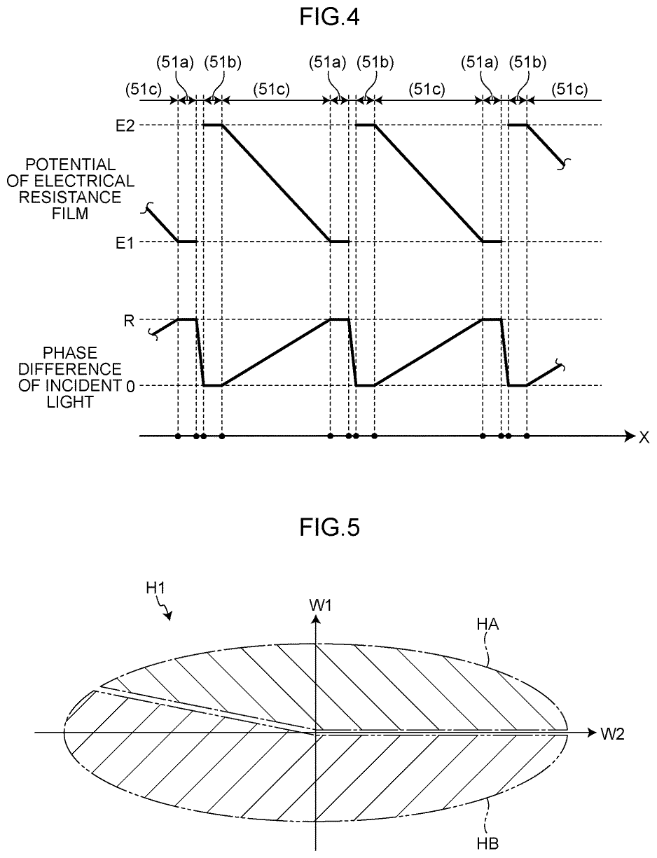

FIG. 4 is a diagram illustrating the potential of each electrical resistance film 51 when the liquid crystal element 40 refracts the incident light L2, and the phase difference of the incident light L2 passing through the liquid crystal layer 43.

The horizontal axis illustrated in FIG. 4 represents position (coordinate) in the X direction. Arrows corresponding to a reference sign in parentheses illustrated in FIG. 4 indicate the region of a portion of the electrical resistance film 51.

When the liquid crystal element 40 refracts the incident light L2, a non-illustrated control circuit applies a first potential E1 to the first electrode 52 and applies a second potential E2 higher than the first potential E1 to the second electrode 53. The first potential E1 is also applied to the third electrode 60. The first potential E1 is, for example, a reference potential of the control circuit.

In this case, in one electrical resistance film 51, the potential of the second overlap portion 51b contacting the second electrode 53 is equal to the second potential E2. In one electrical resistance film 51, the potential of the middle portion 51c between the first electrode 52 and the second electrode 53 linearly changes from the second potential E2 to the first potential E1, from the negative side toward the positive side in the X direction. In one electrical resistance film 51, the potential of the first overlap portion 51a contacting the first electrode 52 is equal to the first potential E1.

The potential difference between the first potential E1 and the second potential E2 depends on the angle between the first direction D1 and the second direction D2. In other words, the angle between the first direction D1 and the second direction D2 can be adjusted by the potential difference between the first potential E1 and the second potential E2.

An electric field generated by potential application to the first electrode 52, the second electrode 53, and the third electrode 60 acts on the liquid crystal layer 43, and the liquid crystal molecules LM are tilted. Accordingly, the refractive index of the liquid crystal layer 43 changes in the X direction, and a phase difference occurs in the incident light L2 passing through the liquid crystal layer 43.

As for the phase of the incident light L2 passing through the liquid crystal layer 43 illustrated in FIG. 4, the phase at a position corresponding to an end of one electrical resistance film 51 on the most negative X side (that is, end of the second overlap portion 51b on the most negative X side) in the X direction is defined as a reference (that is, the phase difference is 0 (zero)), and the maximum value of a phase difference that occurs due to the potential of the electrical resistance film 51 when potential is applied to the first electrode 52 and the second electrode 53 is defined as a maximum phase difference R. A solid line representing the phase difference of the incident light L2 illustrated in FIG. 4 indicates a locus having the same phase as the reference phase.

The phase difference of the incident light L2 passing through the liquid crystal layer 43 changes in a zigzag manner in the X direction between 0 (zero) and the maximum phase difference R. Specifically, the phase difference at a portion of the liquid crystal layer 43 corresponding to the second overlap portion 51b is 0 (zero). From the negative X side toward the positive X side in the X direction, the phase difference at a portion of the liquid crystal layer 43 corresponding to the middle portion 51c linearly changes from 0 (zero) to the maximum phase difference R. The phase difference at a portion of the liquid crystal layer 43 corresponding to the first overlap portion 51a is the maximum phase difference R.

From the negative X side toward the positive X side in the X direction, the phase difference between two electrical resistance films 51 adjacent to each other in the X direction linearly changes from the maximum phase difference R to 0 (zero).

The gradient of the phase difference at the portion of the liquid crystal layer 43 corresponding to the middle portion 51c corresponds to the angle between the first direction D1 and the second direction D2. The length of the portion of the liquid crystal layer 43 corresponding to the middle portion 51c in the X direction is longer than the summed length of the portions of the liquid crystal layer 43 corresponding to the first overlap portion 51a and the second overlap portion 51b.

As the phase difference of the incident light L2 passing through the liquid crystal layer 43 changes as illustrated in FIG. 4, the incident light L2 is refracted by the liquid crystal layer 43 and exits from the liquid crystal element 40 as the second transmitted light L3b along the second direction D2.

In this manner, the first region A1 of the liquid crystal element 40 can refract the incident light L2 with a simple configuration.

The transmitted light L3 from the liquid crystal element 40 is incident on a second lens 70 illustrated in FIG. 1, and the transmitted light L3 is diffused by the second lens 70 and exits from the second lens 70. The second lens 70 includes a second incident surface 71, a reflection surface 72 (corresponding to “second surface”), and a second light-exit surface 73 (corresponding to “first surface”).

The transmitted light L3 is incident on the second incident surface 71. The second incident surface 71 is disposed apart from the first light-exit surface 40b of the liquid crystal element 40. The second incident surface 71 may contact the first light-exit surface 40b. In this case, the liquid crystal element 40 and the second lens 70 are integrated.

The reflection surface 72 is tilted relative to the second incident surface 71. The degree of tilt of the reflection surface 72 with respect to the second incident surface 71 is determined as follows. The reflection surface 72 totally reflects, in a third direction D3 toward the second light-exit surface 73, the first transmitted light L3a incident along the first direction D1. The reflection surface 72 refracts the second transmitted light L3b incident along the second direction D2 to cause the second transmitted light L3b to exit in a fourth direction D4 away from the second light-exit surface 73.

The second light-exit surface 73 diffuses the first transmitted light L3a totally reflected by the reflection surface 72, and the first transmitted light L3a exits as light L4. The second light-exit surface 73 has a spherical surface. The light L4 is light emitted from the illumination device 1.

The following describes operation of the illumination device 1 for a case where the illumination device 1 is a headlight of a vehicle. The control circuit sets an area to be illuminated by the illumination device 1 to one of a first illumination area H1 and a second illumination area H2.

FIG. 5 is a diagram illustrating the first illumination area H1. The light L4 emitted from the illumination device 1 corresponding to the first illumination area H1 corresponds to a so-called high beam.

A W1 direction illustrated in the diagram corresponds to the vertical direction. The positive W1 side in the W1 direction corresponds to the upper side in the vertical direction. The negative W1 side in the W1 direction corresponds to the lower side in the vertical direction. A W2 direction corresponds to a right-left direction when an occupant of the vehicle faces the traveling direction of the vehicle. The lane for the vehicle with the illumination device 1 is on the negative W2 side in the W2 direction. The oncoming traffic lane is on the positive W2 side in the W2 direction.

When the illumination device 1 illuminates the first illumination area H1, the control circuit applies no potential to the element sets 50 and the third electrode 60. In this case, as described above, the first transmitted light L3a along the first direction D1 exits from the first region A1 and the second region A2 of the liquid crystal element 40.

In the second lens 70 illustrated in FIG. 1, the first transmitted light L3a is totally reflected toward the second light-exit surface 73 by the reflection surface 72 and exits from the second light-exit surface 73 as the light L4. The light L4 is projected to the outside of the vehicle. In other words, the first transmitted light L3a transmitted through the first region A1 and the second region A2 of the liquid crystal element 40 is projected toward the outside of the vehicle. An area illuminated with the light L4 corresponds to the first illumination area H1.

In FIG. 5, a first partial area HA illustrated with dashed and single-dotted lines in the first illumination area H1 is an area corresponding to the first transmitted light L3a that exits from the first region A1 of the liquid crystal element 40. A second partial area HB illustrated with dashed and double-dotted lines in the first illumination area H1 is an area corresponding to the first transmitted light L3a that exits from the second region A2 of the liquid crystal element 40. The first illumination area H1 is an area obtained by combining the first partial area HA and the second partial area HB.

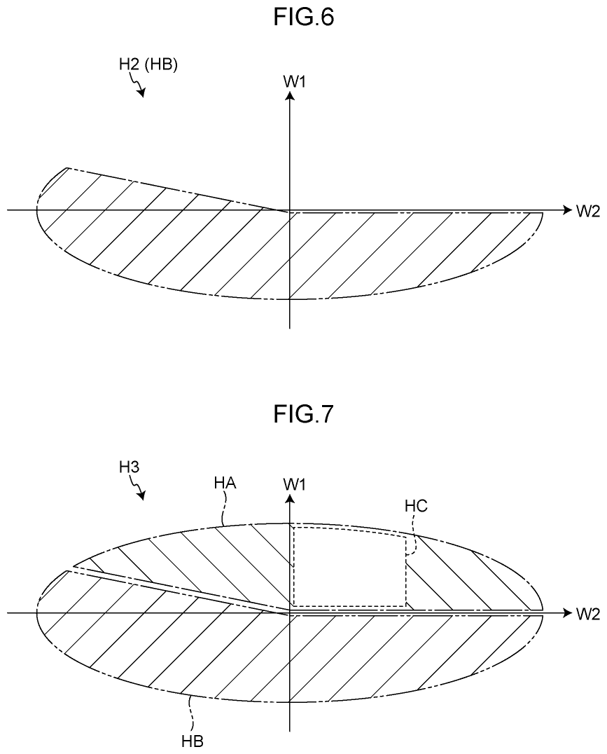

FIG. 6 is a diagram illustrating the second illumination area H2. The light L4 emitted from the illumination device 1 corresponding to the second illumination area H2 corresponds to a so-called low beam. Accordingly, the second illumination area H2 is set to an area with which an oncoming vehicle is not illuminated.

When the illumination device 1 illuminates the second illumination area H2, the control circuit applies potential to the element sets 50 and the third electrode 60. In this case, as described above, the first transmitted light L3a along the first direction D1 exits from the second region A2 of the liquid crystal element 40. As described above, the second transmitted light L3b along the second direction D2 exits from the first region A1 of the liquid crystal element 40.

In the second lens 70, the first transmitted light L3a that exits from the second region A2 of the liquid crystal element 40 is totally reflected toward the second light-exit surface 73 by the reflection surface 72 and exits from the second light-exit surface 73 as the light L4. In other words, the first transmitted light L3a transmitted through the second region A2 of the liquid crystal element 40 is projected as the light L4 toward the outside of the vehicle.

In the second lens 70, the second transmitted light L3b that exits from the first region A1 of the liquid crystal element 40 is refracted at the reflection surface 72 and exits from the second lens 70. The second transmitted light L3b refracted by the reflection surface 72 is not projected to the outside of the vehicle.

In this case, the area illuminated with the light L4 corresponds to the second illumination area H2. The second illumination area H2 is an area corresponding to the first transmitted light L3a that exits from the second region A2 of the liquid crystal element 40. That is, the second illumination area H2 illustrated in FIG. 6 is the same as the second partial area HB. The brightness of the second partial area HB is equal to the brightness of the second illumination area H2.

In this manner, the first illumination area H1 and the second illumination area H2 are switched depending on whether potential is applied to the element sets 50 and the third electrode 60. Thus, the light control device 30 can easily switch the illumination area.

Preferable embodiments of the present disclosure are described above, but the present disclosure is not limited to such embodiments. Contents disclosed in the embodiments are merely exemplary, and various kinds of modifications are possible without departing from the scope of the present disclosure. Any modification performed as appropriate without departing from the scope of the present disclosure belongs to the technical scope of the present disclosure.

For example, the illumination device 1 may include, in place of the first lens 20, a reflective plate that collimates the light L1 from the light source 10 so that the light L1 is incident on the liquid crystal element 40 as the incident light L2. In place of the light L1 from the light source 10, natural light may be incident on the light control device 30.

The first region A1 is not limited to a trapezoidal shape in plan view and may be a polygonal shape such as a triangular shape or a quadrilateral shape. The shapes of the first region A1 and the second region A2 are defined based on a desired first illumination area H1 and a desired second illumination area H2.

Each first coupling member 54 may couple three or more first electrodes 52 electrically in parallel. Each second coupling member 55 may couple three or more second electrodes 53 electrically in parallel.

The liquid crystal element 40 may include no first coupling members 54 and no second coupling members 55. In this case, the first electrodes 52 are electrically isolated from each other. In addition, the second electrodes 53 are electrically isolated from each other.

The electrical resistance films 51 and the first electrodes 52 may be separated while being electrically coupled. In this case, the potential gradient and the gradient of the phase difference illustrated in FIG. 4 change. The electrical resistance films 51 and the second electrodes 53 may be separated while being electrically coupled.

FIG. 7 is a diagram illustrating a third illumination area H3 illuminated by the illumination device 1 according to a modification of the embodiment of the present disclosure. The control circuit sets the area to be illuminated by the illumination device 1 to one of the first illumination area H1, the second illumination area H2, and the third illumination area H3.

In the liquid crystal element 40, the first electrodes 52 and the second electrodes 53 are disposed as described above in the embodiment, and thus the element sets 50 include at least two element sets 50 electrically isolated from each other. In the present modification, the control circuit selects, from among the element sets 50, an element set 50 to which potential is to be applied, thereby setting the area to be illuminated by the illumination device 1 to the third illumination area H3.

Specifically, in FIG. 2, potential is applied to a first electrode set C1a that is one of the first electrode sets C1. In addition, potential is applied to a second electrode set C2a that is one of the second electrode sets C2. In this case, among the element sets 50 in the first region A1, potential is applied to the element sets 50 in a third region A3 overlapping the electrical resistance films 51 corresponding to the one first electrode set C1a and the one second electrode set C2a in plan view. The third region A3 is a part of the first region A1.

Accordingly, the transmitted light L3 that exits from the third region A3 of the liquid crystal element 40 corresponds to the second transmitted light L3b along the second direction D2. Therefore, the transmitted light L3 that exits from the third region A3 of the liquid crystal element 40 exits along the fourth direction D4 through the reflection surface 72 of the second lens 70 and is not projected to the outside of the vehicle.

A third partial area HC illustrated in FIG. 7 is an area corresponding to the third region A3. The third partial area HC is an area with which an oncoming vehicle is not illuminated.

The transmitted light L3 that exits from a region other than the third region A3 in the first region A1 of the liquid crystal element 40 and from the second region A2 corresponds to the first transmitted light L3a along the first direction D1. As a result, the transmitted light L3 that exits from the region other than the third region A3 in the first region A1 of the liquid crystal element 40 and from the second region A2 is projected as the light L4 from the second light-exit surface 73 of the second lens 70 to the outside of the vehicle.

Accordingly, the third illumination area H3 corresponds to an area obtained by combining the first partial area HA and the second partial area HB except for the third partial area HC.

In this manner, the control circuit selects, from among the element sets 50, the element set 50 to which potential is to be applied, whereby the third illumination area H3 is set to an area with which an oncoming vehicle is not illuminated and that is wider than the second illumination area H2.

It should be understood that the present disclosure provides any other effects achieved by aspects described above in the above-described embodiments, such as effects that are clear from the description of the present specification or effects that could be thought of by the skilled person in the art as appropriate.

What is claimed is:

1. A light control device comprising:
a liquid crystal element including a first substrate, a second substrate, and a liquid crystal layer between the first substrate and the second substrate, the liquid crystal element being configured to transmit incident light that is incident along a first direction to cause the incident light to exit therefrom as transmitted light; and
a lens on which the transmitted light from the liquid crystal element is incident and that has a first surface through which the transmitted light is diffused and exits, wherein
the liquid crystal element includes
a first region in which a plurality of element sets are disposed on the first substrate, each element set including an electrical resistance film and a first electrode and a second electrode electrically coupled to the electrical resistance film while facing each other, and in which a third electrode overlapping the electrical resistance film in plan view is disposed on the second substrate, and
a second region in which the electrical resistance film is not disposed,
the first region of the liquid crystal element is configured to cause the incident light to exit in the first direction when no potential is applied to the element sets and the third electrode, and cause the incident light to exit in a second direction different from the first direction when potential is applied to the element sets and the third electrode,
the second region of the liquid crystal element is configured to cause the incident light to exit in the first direction, and
the lens further has a second surface that totally reflects the transmitted light incident along the first direction toward the first surface in a third direction, and that refracts the transmitted light incident along the second direction to cause the transmitted light to exit therethrough in a fourth direction away from the first surface.

2. The light control device according to claim 1, wherein the element sets include at least two element sets electrically isolated from each other.

3. The light control device according to claim 1, wherein in plan view, the liquid crystal layer overlaps the first region and is isolated from the second region.

4. The light control device according to claim 1, wherein a first potential is applied to the first electrode, and a second potential higher than the first potential is applied to the second electrode.

5. An illumination device comprising:
the light control device according to claim 1; and
a light source configured to emit light to be incident on the light control device.
